(19) United States
(12) Patent Application Publication
(10) Pub. No.: US 2007/0237082 A1
(43) Pub. Date: Oct. 11, 2007

(54) Techniques for sharing connection queues and performing congestion management

(76) Inventor: Woojong Han, Phoenix, AZ (US)

Correspondence Address: KACVINSKY LLC;C/O INTELLEVATE, P.O. BOX 52050, MINNEAPOLIS, MN, 55402, US

(21) Appl. No.: 11/394,899

(22) Filed: Mar. 31, 2006

(51) Int. Cl. H04J 1/16; H04L 12/56

(52) U.S. Cl. 370/235; 370/412

(57) ABSTRACT

Various embodiments for sharing connection queues and/or performing congestion management in an Advanced Switching Interconnect (ASI) switched fabric network are described. In one embodiment, an ASI endpoint may comprise a plurality of connection queues including at least one sharable connection queue to be shared among multiple traffic flows to the ASI endpoint. Other embodiments are described and claimed.

### BACKGROUND

Advanced Switching Interconnect (ASI) is a switched fabric technology which provides standardization for communications system applications. ASI is based on the Peripheral Component Interconnect Express (PCIe) architecture and utilizes a packet-based transaction layer protocol that operates over PCIe physical and data link layers. The ASI Special Interest Group (ASI-SIG™) is a collaborative trade organization chartered with developing and supporting ASI as a switched fabric interconnect standard for communications, storage, and embedded equipment.

ASI supports a number of Quality of Service (QoS) features for multi-host, peer-to-peer communications devices such as blade servers, clusters, storage arrays, telecom routers, and switches. These features include support for congestion management techniques such as explicit congestion notification (ECN) and status-based flow control (SBFC), for example. In general, ECN is used to notify an upstream device of congestion encountered by a downstream device, and SBFC enables an upstream device to modify the transmission of packets to avoid congestion. Although ASI supports the capability of ECN and SBFC, however, ASI does not define the particular implementation of such congestion management techniques.

### BRIEF DESCRIPTION OF THE DRAWINGS

FIG. 1 illustrates one embodiment of an ASI switched fabric network.

FIG. 2 illustrates one embodiment of an ASI endpoint.

FIG. 3 illustrates one embodiment of an ASI endpoint.

FIG. 4 illustrates one embodiment of a connection queue data structure.

FIG. 5 illustrates one embodiment of a logic first flow.

FIG. 6 illustrates one embodiment of a logic second flow.

### DETAILED DESCRIPTION

Various embodiments are directed to sharing connection queues (CQs) and/or performing congestion management in a communications system, such as an ASI switched fabric network. In one embodiment, an ASI endpoint in an ASI switched fabric network may comprise multiple internal queues including a plurality of CQs. One or more of the CQs may comprise a sharable CQ configured to be shared among multiple traffic flows supported and/or received by the ASI endpoint. Multiple CQs may be grouped together to form CQ groups (CQGs), and each CQG may comprise one or more sharable CQs. In various implementations, an ASI endpoint may be arranged to support congestion management (CM) techniques such as ECN and SBFC, for example. In such implementations, an ASI endpoint may comprise sharable CQs and CQGs to efficiently support ECN and/or SBFC based congestion management.

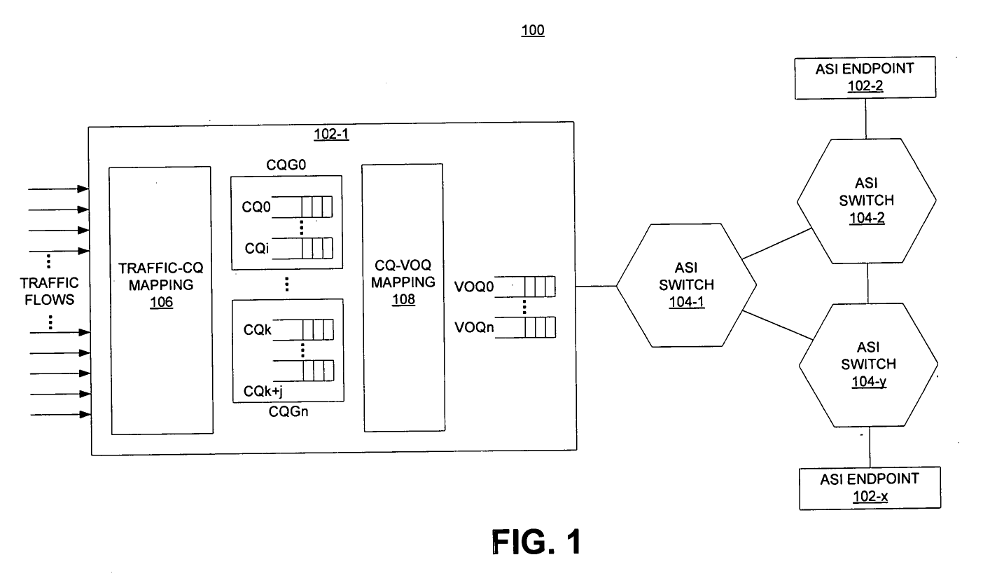

FIG. 1 illustrates a block diagram of an ASI switched fabric network 100. As shown, the ASI switched fabric network 100 may comprise multiple nodes including a plurality of ASI endpoints, such as ASI endpoints 102-1-x, and a plurality of ASI switches 104-1-y, where x and y may represent any positive integer value. The nodes generally may comprise physical or logical entities for communicating information in the ASI switched fabric network 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

The ASI switched fabric network 100 may be arranged to communicate information segmented into a series of data packets. Each data packet may comprise, for example, a discrete data set having a fixed or varying size represented in terms of bits or bytes. The information may include one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner.

The ASI endpoints 102-1-x may be arranged on the edges of the ASI switched fabric network 100 to provide data ingress and egress points for the ASI switched fabric network 100. In various implementations, the ASI endpoints 102-1-x may encapsulate and/or translate data packets entering and exiting the ASI switched fabric network 100 and may connect the ASI switched fabric network 100 to other interfaces or devices peripheral to the ASI switched fabric network 100. Each of the ASI endpoints 102-1-x may comprise, for example, a processor such as a network processor, digital signal processor (DSP), chip multiprocessor (CMP), media processor, or other type of communications processor, a processing unit such as a central processing unit (CPU) or network processing unit (NPU), a chipset such as a CPU chipset or NPU chipset, a chip such as a Fabric Interface Chip (FIC) or other ASI chip, a card such as a line card or control card, a media access device, a host device, server blades, single board computers, or other type of endpoint device. The embodiments are not limited in this context.

The ASI switches 104-1-y may be arranged as intermediate nodes of the ASI switched fabric network 100. The ASI switches 104-1-y may be implemented, for example, by a switch element or switch card configured to provide interconnects among the ASI switches 104-1-y and the ASI endpoints 102-1-x. In various embodiments, each of the ASI endpoints 102-1-x and the ASI switches 104-1-y may comprise an ASI interface for transferring data packets over a common set of physical and data link layers. In some cases, the ASI interface may utilize a packet-based transaction layer protocol (TLP) that operates over PCIe physical and data link layers.

The ASI endpoints 102-1-x and the ASI switches 104-1-y may be interconnected through the ASI switched fabric network 100 by links arranged to establish a dedicated connection between a source node and a destination node. Each link in the ASI switched fabric network 100 may include multiple virtual channels (VCs). In various embodiments, the VCs may be used to isolate traffic flows through the ASI switched fabric network 100. Each VC may comprise, for example, an endpoint-to-endpoint logical path through the ASI switched fabric network 100. Multiple VCs may share a physical link, with each VC comprising dedicated resources or bandwidth of the physical link.

The ASI switched fabric network 100 may support multiple types of VCs including, for example, Bypass-able VCs (BVCs), Ordered VCs (OVCs), and Multicast VCs (MVCs). BVCs may comprise unicast VCs with bypass capability, which may be necessary for deadlock-free tunneling of some protocols (e.g., load/store, protocols). OVCs may comprise single-queue unicast VCs, which are suitable for message-oriented ordered traffic flows. MVCs may comprise single-queue VCs for multicast ordered traffic flows.

The ASI switched fabric network 100 may be arranged to support multiple traffic classes (TCs) to allow traffic flows to be prioritized. In some embodiments, up to eight TCs (TC0-TC7) may be supported for each VC type (e.g., BVC, OVC, MVC). The TCs may be assigned to group traffic flows for similar treatment and allow differentiated service through the ASI switched fabric network 100. For example, each TC can be configured with a specific priority, and the ASI switched fabric network 100 may provide various QoS guarantees, such as maximum latency or minimum bandwidth, for a given TC. In some cases, the TCs can be utilized to support priority-based messaging and data delivery and help prevent head-of-line (HOL) blocking.

The ASI switched fabric network 100 may be arranged to employ source-based routing in which the source of a data packet provides all the information required to route the data packet to a desired destination. The source-based routing may require the data packet to include a header specifying a particular path to the destination. In various implementations, the header may be set at the transmission source and carried end-to-end through the ASI switched fabric network 100.

The data packet may comprise an ASI packet having a header and an encapsulated payload. In various embodiments, the header may specify a TC for the packet and may indicate the VC type and cast type (e.g., unicast, multicast). The header also may specify a path defined by a turn pool, a turn pointer, and a direction flag. The turn pointer may indicate the position of a switch turn value within the turn pool, and the switch turn value may be used to determine an egress port at a switch. When a data packet is received, the header information may be used to extract the turn value.

The header also may specify the Protocol Interface (PI) of the data packet and/or the encapsulated payload. In some embodiments, the PI may be set by a source node and indicate a protocol encapsulation identity (PEI) to be used by a destination node for correctly interpreting the contents of the data packet and/or encapsulated payload. Examples of a PEI may include PCIe, an ASI-SIG defined PEI, or vendor-defined PEI such as an Ethernet, Fibre Channel, ATM (Asynchronous Transfer Mode), InfiniBands, or SLS (Simple Load Store) protocol. In some implementations, data packets may be routed through the ASI switched fabric network 100 using the information contained in the header without interpreting the contents of the data packet. The separation of routing information from the remainder of the data packet enables the AS switched fabric network 100 to simultaneously tunnel data packets using a variety of protocols.

The ASI endpoint 102-1 may be arranged to provide an ingress point to the switched fabric network 100 for multiple traffic flows. In various embodiments, the ASI endpoint 102-1 may comprise multiple internal queues for managing traffic flows. The ASI endpoint 102-1 may comprise, for example, a plurality of connection queues (CQs) arranged to segregate the traffic flows supported and/or received by the ASI endpoint 102-1. In various implementations, the CQs may be implemented in the ASI endpoint 102-1 by software and/or hardware.

When implemented by software, the ASI endpoint 102-1 may comprise a CQ for each and every traffic flow. In many cases, however, the number of traffic flows tunneled to the ASI endpoint 102-1 may be greater than the number of CQs provided by the ASI endpoint 102-1. For example, it may be desirable or necessary to implement the CQs in hardware to achieve performance requirements. When implemented by hardware, however, the number of CQs may be limited by the amount of silicon real estate available for the fabric interface due to cost concerns.

In the embodiment of FIG. 1, for example, the ASI endpoint 102-1 may comprise a plurality of CQs including CQ0 through CQi and CQk through CQk+j, where i, j, and k represent positive integer values and i<k<j. In this embodiment, the number of CQs provided by the endpoint 102-1 (e.g., k+j) may be less than the number of traffic flows supported and/or received by the ASI endpoint 102-1. The CQs may be implemented, for example, by hardware in the ASI endpoint 102-1.

In various embodiments, one or more of the CQs (e.g., CQ0-CQk+j) may comprise a sharable CQ. Each sharable CQ may be configured to be shared among multiple traffic flows. The ASI endpoint 102-1 may be arranged to share multiple traffic flows based on a CQ tuple, such as a {TC, VC type, cast type} tuple, for example. In one embodiment, all traffic flows within a CQ may be required to have the same CQ tuple {TC, VC type, cast type}, and the ASI endpoint 102-1 may comprise at least one sharable CQ per supported CQ tuple. In other embodiments, the traffic flows can be further segregated by the PI, the final destination, and/or other application specific criteria.

As shown in FIG. 1, the ASI endpoint 102-1 may comprise traffic-CQ mapping logic 106. In various embodiments, the traffic-CQ mapping logic 106 may be arranged to map the traffic flows to CQs (e.g., CQ0-CQk+j) in the ASI endpoint 102-1. The traffic-CQ mapping logic 106 may map a traffic flow to a particular CQ based on a CQ tuple {TC, VC type, cast type}, for example. In various implementations, the number of traffic flows may be greater than the number of CQs, and the traffic-CQ mapping logic 106 may map multiple traffic flows to a shared CQ. The ASI endpoint 102-1 may assign a packet from a traffic flow to a particular CQ by specifying a flow identifier (flow ID) in the header of the packet.

The ASI endpoint 102-1 may comprise a plurality of CQ groups (CQGs). In the embodiment of FIG. 1, for example, the ASI endpoint 102-1 may comprise CQGs (CQG0-CQGn), where n may represent any positive integer value. As shown, CQG0 may include one or more CQs including CQ0 through CQi, and CQGn may include one or more CQs including CQk through CQk+j. In various implementations, the traffic-to-CQ mapping logic 106 may be arranged to direct an application traffic flow to a specific CQ within a CQG.

In various embodiments, each CQG (e.g., CQG0-CQGn) may comprise at least one sharable CQ. In some cases, a CQG may comprise multiple sharable CQs. In general, each CQG will include at least one sharable CQ unless software ensures that there is no CQ overrun for the specific CQG.

The ASI endpoint 102-1 may comprise multiple internal queues including, for example, a plurality of virtual output queues (VOQs). The VOQs may be implemented in the ASI endpoint 102-1 by software and/or hardware. In various embodiments, the VOQs may be arranged to receive data packets from CQs and buffer the data packets for transmission into the ASI switched fabric network 100. In various implementations, the data packets form the VOQs may be injected into the ASI switched fabric network 100 through a fabric interface lower layer such as a data link layer and physical layer.

As shown in FIG. 1, the ASI endpoint 102-1 may comprise CQ-VOQ mapping logic 108. In various implementations, the CQ-VOQ mapping logic 106 may be arranged to map the CQs (e.g., CQ0-CQk+j) to the VOQs (e.g., VOQ0-VOQn) in the ASI endpoint 102-1. The CQ-VOQ mapping logic 108 may map a particular CQ to a specific VOQ based on the CQG of the CQ, for example. In various embodiments, the total number of CQGs is equal to the number of VOQs, and each of the CQGs (e.g., CQG0-CQGn) may comprise any number of CQs.

In various implementations, the described embodiments may provide an efficient technique to share one or more CQs among multiple traffic flows. When implemented in hardware, the sharable CQs may reduce the amount of silicon space required to support many simultaneous traffic flows.

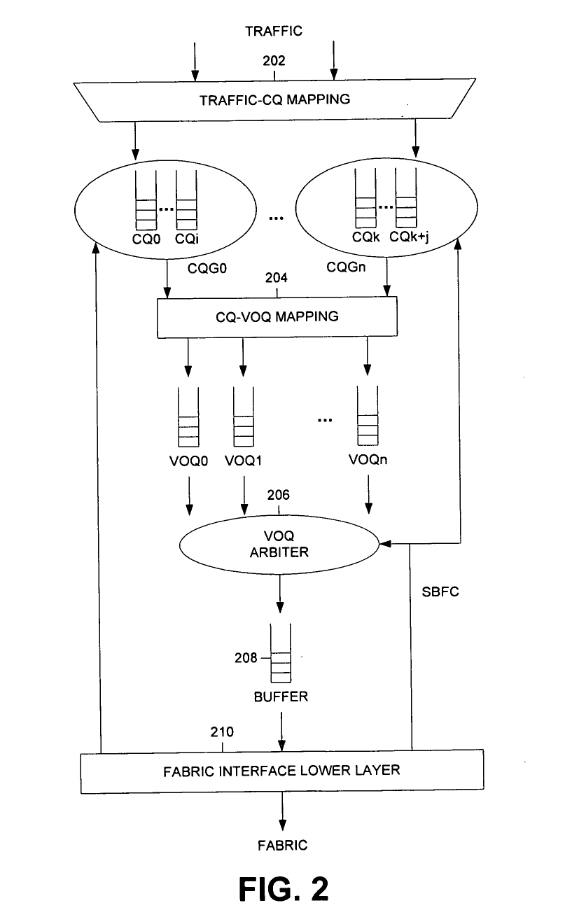

FIG. 2 illustrates a block diagram of an ASI endpoint 200. In various embodiments, the ASI endpoint 200 may be implemented as the ASI endpoint 102-1 of FIG. 1. The embodiments, however, are not limited in this context.

As shown, the ASI endpoint 200 may comprise a plurality of CQs including CQ0 through CQi and CQk through CQk+j, where i, j, and k represent positive integer values and i<k<j. The ASI endpoint 200 may comprise a plurality of CQGs (CQG0-CQGn), where n may represent any positive integer value. As shown, CQG0 may include CQ0 through CQi, and CQGn may include CQk through CQk+j.

In various embodiments, one or more of the CQs (e.g., CQ0-CQk+j) may comprise a sharable CQ configured to be shared among multiple traffic flows. The ASI endpoint 200 may be arranged to share multiple traffic flows based on a CQ tuple, such as a {TC, VC type, cast type} tuple, for example. In various implementations, each CQG (e.g., CQG0-CQGn) may comprise at least one sharable CQ.

The ASI endpoint 200 may comprise traffic-CQ mapping logic 202. In various embodiments, the traffic-CQ mapping logic 202 may be arranged to map the traffic flows to a specific CQ within a CQG. The traffic-CQ mapping logic 202 may map a traffic flow to a particular CQ based on a CQ tuple {TC, VC type, cast type}, for example.

The ASI endpoint 200 may comprise CQ-VOQ mapping logic 204. In various implementations, the CQ-VOQ mapping logic 206 may be arranged to map the CQs (e.g., CQ0-CQk+j) to a plurality of VOQs (e.g., VOQ0-VOQn). The CQ-VOQ mapping logic 204 may map a particular CQ to a specific VOQ based on the CQG of the CQ, for example. In various embodiments, the total number of CQGs is equal to the number of VOQs, and each of the CQGs (e.g., CQG0-CQGn) may comprise any number of CQs.

In various embodiments, the VOQs may be arranged to pass data packets received from the CQs to a VOQ arbiter 306. In some cases, the VOQ arbiter 306 may send the data packets to a buffer 408. The data packets may be injected from the buffer 408 into the switched fabric network 100 through a fabric interface lower layer 410 such as a data link layer and physical layer.

The ASI endpoint 200 may be arranged to support CM techniques such as ECN and/or SBFC. In various implementations, the ASI endpoint 200 may be arranged to efficiently support both ECN and SBFC in hardware. By supporting ECN, the ASI endpoint 200 may be notified of congestion encountered by an intermediate node (e.g., switch) or destination (e.g., ASI endpoint) in an ASI switched fabric network. By supporting SBFC, the ASI endpoint 200 may modify the transmission of packets to avoid HOL blocking and congestion.

The ASI endpoint 200 may be arranged to receive an ECN message which notifies the ASI endpoint 200 of downstream congestion encountered by a switch or destination in an ASI switched fabric network. In various embodiments, the ECN message may notify the ASI endpoint 200 of congestion for a specific traffic flow. The ECN message may comprise, for example, a flowID corresponding to the congested traffic flow. In response to the ECN message, the ASI endpoint 200 may use the flowID to identify a particular CQ and to throttle the CQ to reduce the congestion.

In various implementations, the ASI endpoint 200 may be provided with injection rate limit control to limit the injection rate of packets based on detected congestion. The injection rate may comprise, for example, the rate that the ASI endpoint 200 injects traffic to an ASI switched fabric network. In various embodiments, the CQs (e.g., CQ0-CQk+j) of the ASI endpoint 200 may implement injection rate control. The CQs with injection rate limit control may be implemented by hardware and/or software.

In various implementations, the ASI endpoint 200 may be arranged to support SBFC. The SBFC may be based, for example, on a SBFC tuple such as a {TC, neighbor egress port} tuple, for example. It is noted that the SBFC tuple is different than the CQ tuple. In various embodiments, the VOQs (e.g., VOQ0-VOQn) of the ASI endpoint 200 may implement SBFC by hardware and/or software.

The ASI endpoint 200 may be arranged to receive a SBFC packet requiring the ASI endpoint 200 to throttle a particular VOQ. The SBFC packet may comprise, for example, a VOQ identifier (VOQ ID) corresponding to the particular VOQ to throttle. In response to the SBFC packet, the ASI endpoint 200 may use the VOQ ID to identify and throttle a particular VOQ to avoid and/or reduce congestion.

In various implementations, throttling a particular VOQ may require throttling corresponding CQs which are the source of the packets to the VOQ. As such, the ASI endpoint 200 may use the VOQ ID and the CQ-VOQ mapping logic 204 to identify a particular a CQG corresponding to the VOQ ID. In some embodiments, all CQs within the CQG are throttled since all traffic flows from the CQG are directed to the throttled VOQ. In some cases, all packets in a shared CQ may be throttled, since it may expensive to extract the exact packet or traffic flow from a shared CQ that is to be throttled. By grouping the CQs by the VOQ and implementing CQs with rate limit control, the ASI endpoint 200 provides finer resolution of control so that less innocent traffic is punished by SBFC to enable more efficient support for both ECN and SBFC based congestion management.

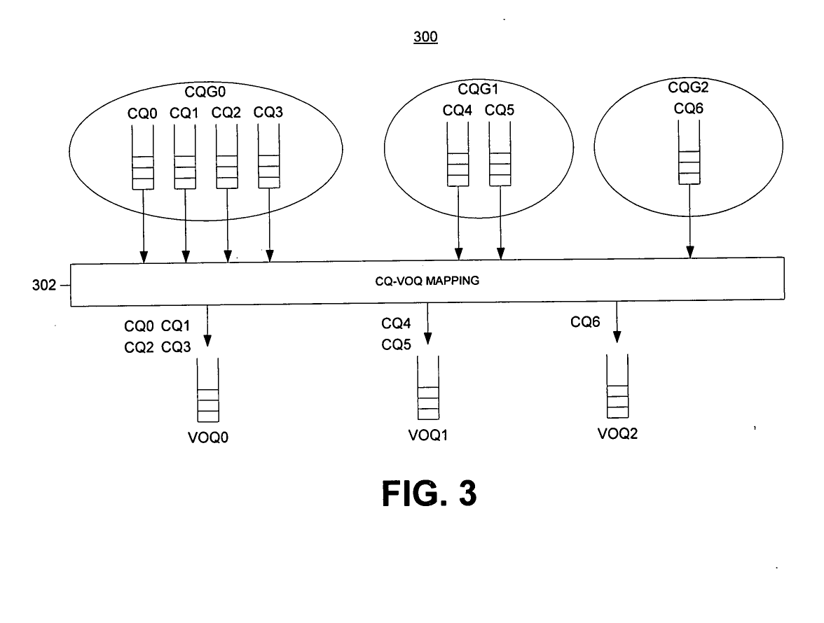

FIG. 3 illustrates a block diagram of an ASI endpoint 300. In various embodiments, the ASI endpoint 300 may be implemented as the ASI endpoint 102-1 of FIG. 1 or the ASI endpoint 200 of FIG. 2. The embodiments, however, are not limited in this context.

As shown, the ASI endpoint 300 may comprise multiple internal queues including a plurality of CQs (e.g., CQ0 through CQ6) and a plurality of VOQs (e.g., VOQ0 through VOQ2). The CQs may be implemented, for example, by hardware in the ASI endpoint 300.

The ASI endpoint 300 may comprise a plurality of CQGs (e.g., CQG0 through CQG2). The number of CQGs may be equal to the number of VOQs. As shown, CQG0 may include CQ0 through CQ3, CQG1 may include CQ4 and CQ5, and CQG2 may include CQ6. In various implementations, the grouping of CQs may be configured by software along with upper layer hardware. In such implementations, a user may be provided with flexibility to assign CQs to CQGs based on application needs and the number of supported VOQs.

In various embodiments, one or more of the CQs (e.g., CQ0-CQ6) may comprise a sharable CQ. Each sharable CQ may be configured to be shared among multiple traffic flows. In various implementations, the seven CQs provided by the ASI endpoint 300 may be less than the number of supported and/or received traffic flows.

In one embodiment, each CQG (e.g., CQG0-CQG2) may comprise at least one sharable CQ. In some cases, a CQG may comprise multiple sharable CQs. In general, each CQG will include at least one sharable CQ unless software ensures that there is no CQ overrun for the specific CQG.

As shown in FIG. 3, the ASI endpoint 300 may comprise CQ-VOQ mapping logic 302. In various implementations, the CQ-VOQ mapping logic 302 may be arranged to map the CQs (e.g., CQ0-CQ6) to the VOQs (e.g., VOQ0-VOQ2) based on the CQGs. As shown, the CQ-VOQ mapping logic 302 may map CQ0, CQ1, CQ2 and CQ3 to VOQ0 based on CQG0. The CQ-VOQ mapping logic 302 also may map CQ4 and CQ5 to VOQ1 based on CQG1 and may map CG6 to VOQ2 based on CQG2.

In some cases, a mapping table for the CQ-VOQ mapping logic 302 may be implemented by software. In other cases, the mapping can be configured by hardware at initialization time, such as when mapping is pre-determined. In various embodiments, the ASI endpoint 300 may implement CQ arbitration logic (e.g., arbiter). In such embodiments, the mapping logic 302 may be integrated into the arbitration logic, since the arbitration logic generally may be required to know the status of the destination.

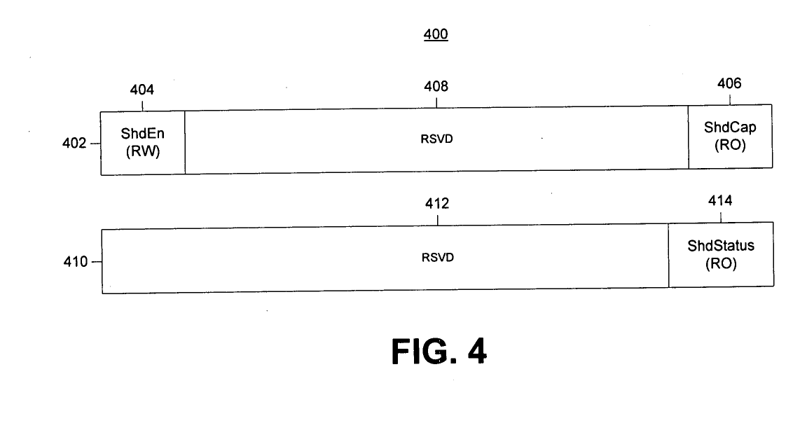

FIG. 4 illustrates one embodiment of a CQ data structure 400. In various embodiments, the CQ data structure 400 may be associated with a CQ in an ASI endpoint, such as the ASI endpoint 102-1 of FIG. 1, ASI endpoint 200 of FIG. 2, or the ASI endpoint 300 of FIG. 3, for example. The embodiments, however, are not limited in this context.

As shown, the CQ data structure 400 may comprise a capability and control register 402. In various embodiments, the capability and control register 402 may be arranged to specify whether a particular CQ is sharable. The capability and control register 402 may comprise, for example, a sharable enable (ShdEn) field 404, a sharable capability (ShdCap) field 406, and a reserved area 408. The ShdEn field 404 may comprise a read-write (RW) field for storing a ShdEn bit (e.g., 0=disabled, 1=enabled to be shared). At reset, the default value of the ShdEn bit is 0. If the value of the ShdEn bit is 0, the bit may be ignored.

The ShdCap field 406 may comprise a read-only (RO) field for storing a ShdCap bit (e.g., 0=CQ cannot be shared, 1=CQ can be shared). In various implementations, software may configure a CQ to be sharable by setting a ShdEn bit to a value of 1 when the ShadCap bit has a value of 1. If the ShdCap bit has the value of 0, the software cannot configure the CQ to be sharable. In some embodiments, at least one CQ per CQG may be designed with a ShdCap field 406 having a ShdCap bit set to 1 so that software may configure the CQ to be sharable by setting the ShdEn bit to 1.

The CQ data structure 400 also may comprise a status register 410. In various embodiments, the status register 402 may be arranged to reflect the exact current shared status of a CQ. The status register 410 may comprise, for example, a reserved area 412, and a shared status (ShdStatus) field 414.

The ShdStatus field 414 may comprise a RO field for storing ShdStatus bits (e.g., 0x=not shared, 10=shared once, 1=shared multiple times). When a ShdCap bit of the capability and control register 402 is not set to the value of 1, the ShdStatus field 414 may be ignored. When first ShdStatus bit of the ShdStatus field 414 is set to 1, the CQ is being shared among multiple traffic flows or applications. When both ShdStatus bits are set to 1, the CQ is being shared by more than three traffic flows or applications.

Operations for various embodiments may be further described with reference to the following figures and accompanying examples. Some of the figures may include a logic flow. It can be appreciated that the logic flow merely provides one example of how the described functionality may be implemented. Further, the given logic flow does not necessarily have to be executed in the order presented unless otherwise indicated. Moreover, particular functions described by the logic flow may be combined or separated in some embodiments. In addition, the logic flow may be implemented by a hardware element, a software element executed by a processor, or any combination thereof. The embodiments are not limited in this context.

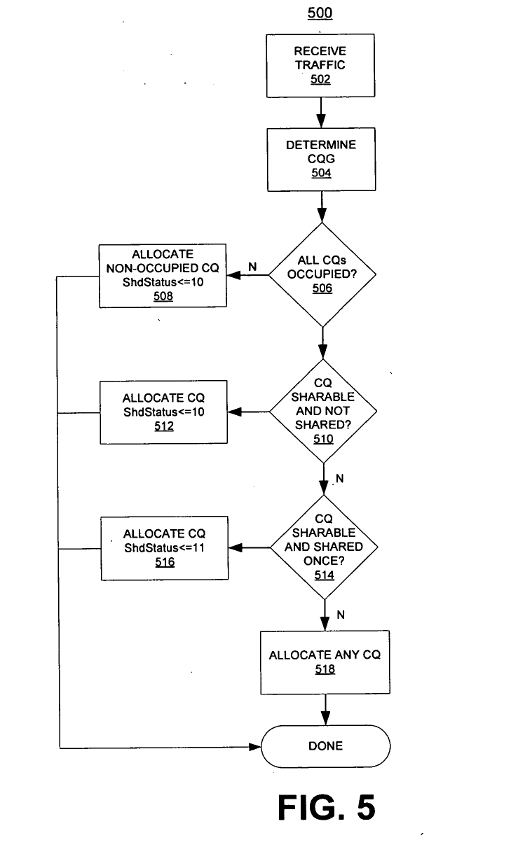

FIG. 5 illustrates one embodiment of a logic flow 500. FIG. 5 illustrates a logic flow 500 for selecting and managing sharable CQs. In various embodiments, the logic flow 500 may be implemented as hardware, software, and/or any combination thereof, as desired for a given set of design parameters or performance constraints. For example, the logic flow 500 may be implemented by a logic device (e.g., ASI endpoint, FIC) and/or logic (e.g., CQ management logic, traffic-CQ mapping logic) comprising instructions and/or code to be executed by a logic device. It can be appreciated that the logic flow 500 may be implemented by various other types of hardware, software, and/or combination thereof.

The logic flow 500 may comprise receiving traffic (block 502). The traffic may comprise, for example, multiple traffic flows received at an ASI endpoint. In various embodiments, the number of traffic flows may be greater than the number of CQs provided by the ASI endpoint.

The logic flow 500 may comprise determining a CQG (block 504). The CQG may be determined based on a CQ tuple {TC, VC type, cast type}, for example. In various embodiments, when application traffic is to be injected to an ASI switched fabric network, software with upper layer hardware support may determine a CQG and direct the traffic for mapping to a particular CQ within the CQG.

The logic flow 500 may comprise determining whether all CQs in the CQG are occupied (block 506). The status of a CQ within a CQG may be determined, for example, by checking a status register. In various embodiments, the status of each CQ within a CQG is checked to identify the most appropriate CQ for the traffic.

The logic flow 500 may comprise allocating the traffic to an unoccupied CQ (e.g., ShdStatus<=10) if there is an unoccupied CQ in the CQG (block 508). If all CQs in the CQG are occupied, the logic flow 500 may comprise determining whether there is a sharable and not shared CQ (e.g., ShdEn=1 and ShdStatus=00) in the CQG (block 506) and allocating the traffic to the CQ (e.g., ShdStatus<=10) if the CQ is sharable and not shared (block 512).

If there are no sharable and not shared CQs in the CQG, the logic flow 500 may comprise determining whether there is a sharable and shared once CQ (e.g., ShdEn=1 and ShdStatus=10) in the CQG (block 514) and allocating the traffic to the CQ (e.g., ShdStatus<=10) if the CQ is sharable and shared once (block 516). If there are no sharable and shared once CQs in the CQG, the logic flow may comprise allocating the traffic to any CQ in the CQG (block 518).

In various implementations, the logic flow 500 may be arranged to select a shareable CQ when there is no dedicated CQ available for the traffic. To provide finer grain of control with multiple sharable CQs per CQG, the logic flow 500 differentiates sharable CQs shared once from sharable CQs shared multiple times.

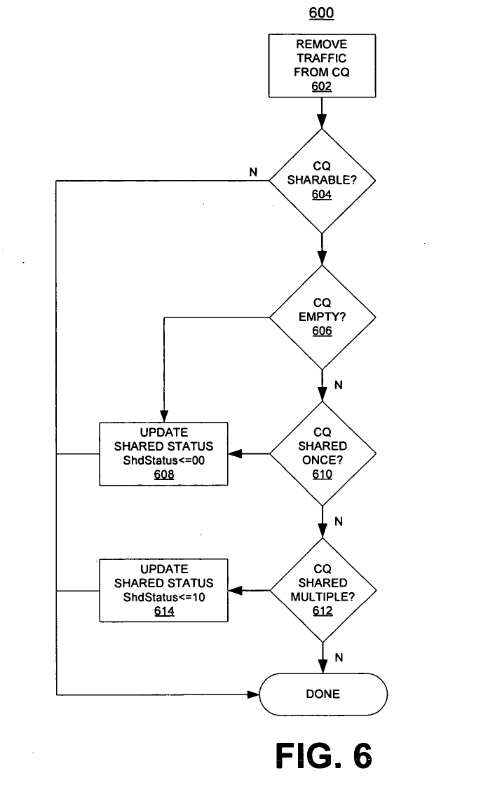

FIG. 6 illustrates one embodiment of a logic flow 600. FIG. 6 illustrates a logic flow 600 for managing sharable CQs. In various embodiments, the logic flow 600 may be implemented as hardware, software, and/or any combination thereof, as desired for a given set of design parameters or performance constraints. For example, the logic flow 600 may be implemented by a logic device (e.g., ASI endpoint, FIC) and/or logic (e.g., CQ management logic, traffic-CQ mapping logic) comprising instructions and/or code to be executed by a logic device. It can be appreciated that the logic flow 600 may be implemented by various other types of hardware, software, and/or combination thereof.

The logic flow may comprise removing traffic from a CQ (block 602) and determining whether the CQ is sharable (block 604) and whether the CQ is empty (block 606). The logic flow 600 may comprise updating the shared status (e.g., ShdStatus<=00) to reflect that the CQ is not being shared (block 608) if the CQ is empty or if the CQ was shared once (block 610). The logic flow 600 may comprise determining whether the CQ was shared multiple times (block 612) and, if so, updating the shared status (e.g., ShdStatus<=10) to reflect that the CQ is being shared once (block 614).

In general, the shared status of a CQ reflects the current shared status and not the past history of sharing. As such, when traffic is removed from the CQ and forwarded to a VOQ, for example, the status must be updated to reflect the current shared status of the CQ.

In various implementations, the described embodiments may provide an efficient sharing technique for using limited hardware-based CQs. By sharing CQs, the described embodiments may provide significant savings for on-chip storage and control logic.

In various implementations, the described embodiments may allow ASI endpoints to efficiently support both ECN and SBFC based congestion management. By grouping CQs, assigning sharable CQs, and providing a flexible queue management technique, the described embodiments allow efficient use of limited internal silicon space while supporting any number of application traffic flows or applications that undergo CQ rate limit control.

In various implementations, the described embodiments may be applied to any type of fabric device or interface implementing a hardware queue to support ECN and/or SBFC type congestion management. The described embodiments may provide a reduction in die size and chip cost without losing performance capability to support congestion management and/or an arbitrary number of applications threads. For example, an arbitrary number of application threads may be supported in a single device without implementing a large number of queues and associated management logic.

Although the described embodiments may be illustrated using a particular communications media by way of example, it may be appreciated that the principles and techniques discussed herein may be implemented using various types of communication media and accompanying technology. For example, the described embodiments may be implemented within a wired communication system, a wireless communication system, or a combination of both. The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), a line card, a disc controller, video controller, audio controller, and so forth.

In various implementations, the described embodiments may communicate information in accordance with one or more standards, such as standards promulgated by the Institute of Electrical and Electronics Engineers (IEEE), the Internet Engineering Task Force (IETF), the International Telecommunications Union (ITU), and so forth. The described embodiments may employ one or more protocols such as a medium access control (MAC) protocol, Physical Layer Convergence Protocol (PLCP), Simple Network Management Protocol (SNMP), ATM protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

In various implementations, the described embodiments may comprise or form part of a network, such as a local area network (LAN), a wide area network (WAN), a metropolitan area network (MAN), a wireless LAN (WLAN), a wireless WAN (WWAN), a wireless MAN (WMAN), a Worldwide Interoperability for Microwave Access (WiMAX) network, a broadband wireless access (BWA) network, a wireless personal area network (WPAN), a spatial division multiple access (SDMA) network, a Code Division Multiple Access (CDMA) network, a Wide-band CDMA (WCDMA) network, a Time Division Synchronous CDMA (TD-SCDMA) network, a Time Division Multiple Access (TDMA) network, an Extended-TDMA (E-TDMA) network, a Global System for Mobile Communications (GSM) network, a GSM with General Packet Radio Service (GPRS) network, an Orthogonal Frequency Division Multiplexing (OFDM) network, an Orthogonal Frequency Division Multiple Access (OFDMA) network, a North American Digital Cellular (NADC) network, a Universal Mobile Telephone System (UMTS) network, a third generation (3G) network, a fourth generation (4G) network, the Internet, the World Wide Web, a cellular network, a radio network, a satellite network, and/or any other communications network configured to carry data.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the registers and/or memories into other data similarly represented as physical quantities within the memories, registers or other such information storage, transmission or display devices.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising:
an advanced switching interconnect (ASI) endpoint comprising a plurality of connection queues, said plurality of connection queues comprising at least one sharable connection queue to be shared among multiple traffic flows to said ASI endpoint.

2. The apparatus of claim 1, further comprising at least one connection queue group including one or more of said plurality of connection queues.

3. The apparatus of claim 2, wherein said at least one connection queue group comprises said at least one sharable connection queue.

4. The apparatus of claim 1, further comprising one or more virtual output queues, said ASI endpoint to map said plurality of connection queues to said one or more virtual output queues.

5. The apparatus of claim 1, said plurality of connection queues to perform injection rate limit control in response to at least one of an explicit congestion notification message and a status-based flow control packet.

6. A system comprising:
a switch; and
an advanced switching interconnect (ASI) endpoint coupled to said switch, said ASI endpoint comprising a plurality of connection queues, said plurality of connection queues comprising at least one sharable connection queue to be shared among multiple traffic flows to said ASI endpoint.

7. The system of claim 6, further comprising at least one connection queue group including one or more of said plurality of connection queues.

8. The system of claim 7, wherein said at least one connection queue group comprises said at least one sharable connection queue.

9. The system of claim 6, further comprising one or more virtual output queues, said ASI to map said plurality of connection queues to said one or more virtual output queues.

10. The system of claim 6, said plurality of connection queues to perform injection rate limit control in response to at least one of an explicit congestion notification message and a status-based flow control packet.

11. A method comprising:
enabling at least one sharable connection queue at an Advanced Switching Interconnect (ASI) endpoint; and
allocating a traffic flow to said sharable connection queue.

12. The method of claim 11, further comprising determining a connection queue group for said traffic flow.

13. The method of claim 12, further comprising allocating a traffic flow to said sharable connection queue if said connection queue group includes no unoccupied connection queue.

14. The method of claim 11, further comprising allocating multiple traffic flows to said sharable connection queue.

15. The method of claim 11, further comprising throttling said sharable connection queue in response to at least one of an explicit congestion notification message and a status-based flow control packet.

16. An article comprising a machine-readable storage medium containing instructions that if executed enable a system to:
enable at least one sharable connection queue at an Advanced Switching Interconnect (ASI) endpoint; and
allocate a traffic flow to said sharable connection queue.

17. The article of claim 16, further comprising instructions that if executed enable a system to determine a connection queue group for said traffic flow.

18. The article of claim 17, further comprising instructions that if executed enable a system to allocate a traffic flow to said shamble connection queue if said connection queue group includes no unoccupied connection queue.

19. The article of claim 16, further comprising instructions that if executed enable a system to allocate multiple traffic flows to said sharable connection queue.

20. The article of claim 16, further comprising instructions that if executed enable a system to throttle said sharable connection queue in response to at least one of an explicit congestion notification message and a status-based flow control packet.

21. The apparatus of claim 1, wherein said at least one sharable connection queue is to be shared among multiple traffic flows based on a tuple comprising traffic class, virtual channel type, and cast type.

22. A system comprising:
an endpoint to a switched fabric comprising a queue group including a plurality of internal hardware queues, said queue group comprising at least one sharable queue to be shared among multiple traffic flows to said endpoint;
a queue data structure associated with said sharable queue, said queue data structure to specify whether said sharable queue is enabled to be shared and to reflect a shared status of said sharable queue; and
queue management logic to allocate a traffic flow to said sharable queue based on said shared status.

23. The system of claim 22, wherein said shared status comprises at least one of not shared, shared once, and shared multiple times.

24. The system of claim 22, said queue management logic to determine a queue group and a particular queue within said queue group for a traffic flow.

25. The system of claim 22, said queue management logic to allocate a traffic flow to said sharable queue if all queues in a queue group are occupied and if said sharable queue is not shared or is shared once.

26. The system of claim 22, said queue management logic to update said shared status of said sharable queue when a traffic flow is removed from said sharable queue.
